(19) United States
(12) Patent Application Publication
(10) Pub. No.: US 2026/0180730 A1
(43) Pub. Date: Jun. 25, 2026

(54) DYNAMIC BRIDGE REPORTING FOR TIME SENSITIVE COMMUNICATION

(71) Applicant: Telefonaktiebolaget LM Ericsson (publ), Stockholm (SE)

(72) Inventors: Dhruvin PATEL, Aachen (DE); Joachim SACHS, Sollentuna (SE); János FARKAS, Kecskemét (HU); János HARMATOS, Budapest (HU); Balázs VARGA, Budapest (HU); Marilet De Andrade JARDIM, Kista (SE); György MIKLÓS, Pilisborosjenö (HU)

(21) Appl. No.: 19/124,938

(22) PCT Filed: Nov. 7, 2022
(86) PCT No.: PCT/SE2022/051023

§ 371 Date: Apr. 28, 2025

(51) Int. Cl. H04L 5/00; H04L 12/46; H04L 47/28; H04L 67/02

(52) U.S. Cl. CPC H04L 5/0023; H04L 5/0048; H04L 12/462; H04L 47/28; H04L 67/02

(57) ABSTRACT

Embodiments of the present disclosure provide a method performed by a network node of a wireless communication network. The wireless communication network operating as a virtual Time-Sensitive Networking, TSN, bridge of a TSN system. The method includes identifying User Equipments, UEs, associated to the virtual TSN bridge of the TSN system. The method includes dividing the UEs into groups according to latency characteristics of the UEs. The method includes associating at least some of the UEs to at least one additional virtual TSN bridge of the TSN system based on the grouping of the UEs. Corresponding network node, and computer program products are also disclosed.

### TECHNICAL FIELD

The present disclosure relates generally to the field of Time Sensitive Networking, TSN, systems. More particularly, it relates to method, network node, and computer program products for dynamic bridge reporting for time sensitive communication.

### BACKGROUND

An automation industry is undergoing a digital transformation towards the “Fourth Industrial Revolution” (Industry 4.0), which involves smart manufacturing. Flexible connectivity infrastructure provided by the automation industry is a key enabler for manufacturing to interconnect machines, products and all kinds of other devices in a flexible, secure, and consistent manner.

Communication technology enablers for the digital transformation of the automation industry are Time Sensitive Networking, TSN, system (TSN network) on a wireline side, and a Third Generation Partnership Project, 3GPP, Fifth Generation, 5G, network on a wireless side. The TSN system is based on the Institute of Electrical and Electronics Engineers, IEEE 802.3 Ethernet standard. The TSN system provides deterministic services through IEEE 802.3 networks, for example, time synchronization, guaranteed low latency transmissions and high reliability. The 5G network, an alternative to a wired connectivity solution supports communication with unprecedented reliability and very low latency, as well as massive Internet of Things, loT, connectivity. Thus, the TSN system and the 5G network are considered as complementary technologies in providing deterministic communication services, thereby paying the way towards future advanced manufacturing systems and other vertical areas. Also, the TSN system and the 5G network are essential for network convergence that is a support of all kinds of communication services via a same network infrastructure. Therefore, the TSN system can be integrated to the 5G network for supporting the deterministic communication services over heterogeneous infrastructure and multiple application domains required for the network convergence. The integration of the TSN system to the 5G system provides converged communication on the same network infrastructure for a wide range of services, for example, time sensitive applications that require deterministic, reliable and low latency communications.

With the integration of the TSN system to the 5G network, the 5G network is deployed as a set of IEEE compliant virtual TSN bridges (also be referred to as virtual TSN nodes, 5G bridges, or the like). The virtual-TSN bridge can be connected to TSN bridges (also be referred to wired TSN bridges/bridges). The 5G network comprises a 5G core network and a Radio Access Network, RAN. The 5G core network comprises a User Plane Function, UPF, which acts as a gateway to the TSN system. The RAN spans over a production plant to provide wireless connectivity to one or more User Equipments, UEs.

The 5G network/virtual TSN bridge defines several gateways between the TSN system and the 5G network. The gateways include a TSN Application Function, AF, device side TSN translators, DS-TTs, on the UEs, and network side TSN translators, NW-TTs, on the UPF. The TSN AF connects a Centralized Network Controller, CNC, a Centralized User Configuration, CUC and a 5G control plane.

The CNC controls/operates the TSN bridges and the virtual TSN bridge as the TSN bridge. However, there exist some substantial differences between the 5G network/virtual TSN bridge and the TSN bridge. As the differences between the virtual TSN bridge and the TSN bridge are hidden, the CNC cannot consider such differences into account while scheduling time sensitive communication in the TSN system. Thus, resulting in suboptimal behaviour with respect to leveraging capabilities of the 5G network and potential benefits for end-to-end time sensitive communication.

A key difference between the TSN bridges and the virtual TSN bridge is that characteristics of the virtual TSN bridge may vary dynamically, especially compared to relatively static characteristics of the TSN bridges. When the characteristics of the virtual TSN bridge change, a new interaction between the virtual TSN bridge and the CNC may be triggered. Currently an interaction model defined for facilitating the virtual TSN bridge and the CNC may function well, only if the virtual TSN bridge is the wired TSN bridge. Thus, the currently defined interaction model may not be suitable for the 5G network operating as the virtual TSN bridge.

In the TSN system integrated to the 5G network, all the UEs are connected to the same UPF (per slice) as a single Ethernet bridge with many ports. Every UE in the TSN system can be considered as one port, in addition the UPF can have multiple ports. All 5G bridge reports (comprising information about the UPF and the associated one or more UEs) can be transmitted towards the CNC, which contain information per port pair. For example, 99 connected UEs and one UPF may have 4950 port pairs to report per bridge. Compared to the 5 GS network/virtual TSN bridge, the wired TSN bridges have static ports and port pair characteristics.

Once bridge report per bridge is sufficient for the wired TSN bridge, which may not be efficient for the virtual TSN bridge. Especially, any change in the UE may lead to an updated bridge report (and many changed port pair characteristics). Also, event-triggered bridge reports are not supposed in the TSN system and if added, this may result in high signaling load and bridge update reporting frequency.

### SUMMARY

Consequently, there is a need for an improved method and arrangement for enabling of reporting multiple bridges, which comprise information identifying an association of a number of user Equipments, UEs, in each group to a corresponding virtual TSN bridge that alleviates at least some of the above-cited problems.

It is therefore an object of the present disclosure to provide a method, a network node, and a computer program product for enabling of reporting multiple bridges comprising information identifying an association of a number of user Equipments, UEs, in each group to a corresponding virtual TSN bridge, to mitigate, alleviate, or eliminate all or at least some of the above-discussed drawbacks of presently known solutions.

This and other objects are achieved by means of a method, a network node, and a computer program product as defined in the appended claims. The term exemplary is in the present context to be understood as serving as an instance, example or illustration.

According to a first aspect of the present disclose, a method performed by a network node of a wireless communication network is provided. The wireless communication network operates as a virtual Time-Sensitive Networking, TSN, bridge of a TSN system. The method comprises identifying User Equipments, UEs, associated to the virtual TSN bridge of the TSN system. The method comprises dividing the UEs into groups according to latency characteristics of the UEs. The method comprises associating at least some of the UEs to at least one additional virtual TSN bridge of the TSN system based on the grouping of the UEs. In some embodiments, the step of dividing the UEs into groups according to latency characteristics of the UEs comprises determining latency characteristics associated with each UE. The method comprises identifying the UEs with varying latency characteristics and the UEs with static latency characteristics based on the determined latency characteristics. The method comprises grouping the UEs with varying latency characteristics in a first group and grouping the UEs with static latency characteristics in at least a second group.

In some embodiments, the step of associating the at least some of the UEs to at least one additional virtual TSN bridge of the TSN system based on the grouping of the UEs comprises determining the number of the UEs in each group, and associating each group of UEs to the at least one additional virtual TSN bridge based on the number of UEs in each group.

In some embodiments, the method further comprises transmitting information identifying the association of the respective UE to the corresponding virtual TSN bridge, said information being intended for a Centralized Network Controller, CNC, of the TSN system.

In some embodiments, the transmitted information to the CNC comprises the information identifying all the UEs (30) in each group associated to each virtual TSN bridge, wherein the UEs (30) in each group represents one port of the associated virtual TSN bridge.

In some embodiments, the transmitted information further comprises port information comprising port pairs, each port pair comprising a port of a UE and a port of its associated virtual TSN bridge.

In some embodiments, the port information comprises information identifying whether the port pair has static latency characteristics or dynamic latency characteristics.

According to a second aspect of the present disclosure, an apparatus of a network node of a wireless communication is provided. The wireless communication network operates as a virtual Time-Sensitive Networking, TSN, bridge of a TSN system. The apparatus is configured to cause identification of User Equipments, UEs, associated to the virtual TSN bridge of the TSN system. The apparatus is configured to cause dividing of the UEs into groups according to latency characteristics of the UEs. The apparatus is configured to cause association of at least some of the UEs to at least one additional virtual TSN bridge of the TSN system based on the grouping of the UEs.

A third aspect is a network node comprising the apparatus of the second aspect.

According to a fourth aspect of the present disclosure, there is provided a computer program product comprising a non-transitory computer readable medium, having thereon a computer program comprising program instructions. The computer program is loadable into a data processing unit and configured to cause execution of the method according to the first aspect when the computer program is run by the data processing unit.

In some embodiments, any of the above aspects may additionally have features identical with or corresponding to any of the various features as explained above for any of the other aspects.

An advantage of some embodiments is that alternative and/or improved approaches are provided for enabling of reporting multiple bridges, which comprises information identifying the association of the number of UEs, in each group to the corresponding virtual TSN bridge.

An advantage of some embodiments is that for enabling of reporting multiple bridges, the UEs are segmented into the one or more groups based on a behaviour of the UEs (i.e., based on the latency characteristics of the UEs) and at least some of the UEs are associated to the at least one additional virtual TSN bridge based on the grouping of the UEs. As a result, the TSN system may be efficiently configured and managed. In addition, such a grouping of the UEs may be advantageous to the virtual TSN bridge with a smaller number of UEs.

An advantage of some embodiments is that the UEs with varying latency characteristics are grouped in the first group and the UEs with static latency characteristics are grouped in at least one second group, wherein a size of the first group may be held smaller than the at least one second group. As a result, a frequency of updating reporting of multiple bridges may be controlled.

An advantage of some embodiments is that updates of reporting multiple bridges are in smaller scale due to the grouping of the UEs based on their latency characteristics, so that other ports associated with the UEs may be affected less.

Other advantages may be readily apparent to one having skill in the art. Certain embodiments may have none, some, or all of the recited advantages.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 discloses an example of a Time Sensitive Networking, TSN, system integrated to a wireless communication network according to some examples;

FIG. 2 discloses an example of a TSN system integrated to a wireless communication network, which acts as a virtual TSN bridge according to some examples;

FIG. 3 discloses an example of a wireless communication network according to some examples;

FIGS. 4A and 4B disclose an example architecture of a TSN system integrated to a wireless communication network according to some examples;

FIG. 5 is a flowchart illustrating example method steps according to some examples;

FIG. 6 is a signaling diagram illustrating example signaling according to some examples;

FIG. 7 is a schematic block diagram illustrating an example apparatus according to some embodiments; and

FIG. 8 discloses an example computing environment according to some examples.

### DETAILED DESCRIPTION

Aspects of the present disclosure will be described more fully hereinafter with reference to the accompanying drawings. The apparatus and method disclosed herein can, however, be realized in many different forms and should not be construed as being limited to the aspects set forth herein. Like numbers in the drawings refer to like elements throughout.

The terminology used herein is for the purpose of describing particular aspects of the disclosure only, and is not intended to limit the invention. It should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Network node: As used herein, a network node (also be referred to as radio access node, radio network node, or the like) is any node in a Radio Access Network, RAN, of a wireless communication network that operates to wirelessly transmit and/or receive signals. Some examples of the network node include, but are not limited to, a base station (for example a New Radio, NR, base station, gNB, in a Third Generation Partnership Project, 3GPP, Fifth Generation, 5G, NR network or an enhanced or evolved Node B, eNB, in a 3GPP Long Term Evolution, LTE, network), a high-power or macro base station, a low-power base station (for example, a micro base station, a pico base station, a home eNB, or the like), a relay node, and so on.

Core network node: As used herein, a core network node is any type of node in a core network that implements a core network function. Some examples of the core network node include, for example, a Mobility Management Entity, MME, a Packet Data Network Gateway, P-GW, a Service Capability Exposure Function, SCEF, a Home Subscriber Server, HSS, or the like. Some other examples of the core network node include a node implementing an Access and Mobility Function, AMF, a User Plane Function, UPF, a Session Management Function, SMF, an Authentication Server Function, AUSF, a Network Slice Selection Function, NSSF, a Network Exposure Function, NEF, a Network Repository Function, NRF, a Policy Control Function, PCF, a Unified Data Management, UDM, and so on.

User Equipment, UE: As used herein, a UE (also be referred to as wireless device) is any type of device that has access to (i.e., is served by) a wireless communication network by wirelessly transmitting and/or receiving signals to a network node(s). Some examples of the UE are a target device, a device to device, D2D, UE, a machine type UE, a UE capable of machine to machine, M2M, communication, personal digital assistant, PDA, tablet, mobile terminals, smart phone, laptop embedded equipped, LEE, laptop mounted equipment, LME, universal serial bus, USB, dongles, UE category M2, ProSe UE, and so on.

Note that the description given herein focuses on a 3GPP wireless communication network and, as such, 3GPP terminology or terminology similar to 3GPP terminology is oftentimes used. However, the concepts disclosed herein are not limited to a 3GPP system.

Embodiments of the present disclosure will be described and exemplified more fully hereinafter with reference to the accompanying drawings. The solutions disclosed herein can, however, be realized in many different forms and should not be construed as being limited to the examples set forth herein.

It will be appreciated that when the present disclosure is described in terms of a method, it may also be embodied in one or more processors and one or more memories coupled to the one or more processors, wherein the one or more memories store one or more programs that perform the steps, services and functions disclosed herein when executed by the one or more processors.

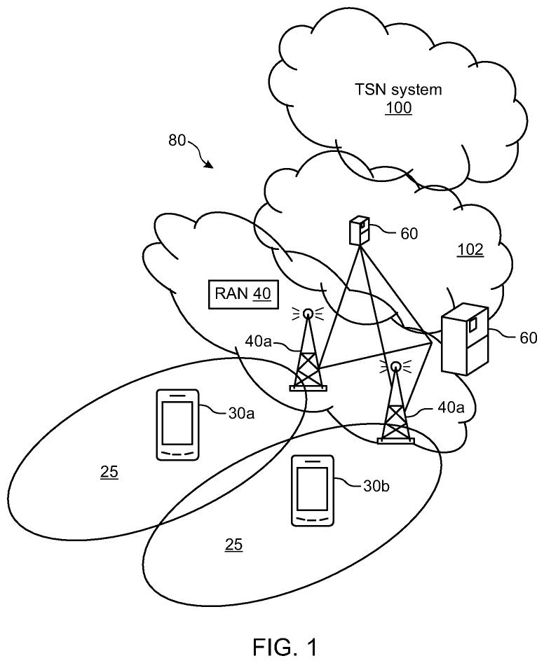

FIG. 1 discloses an example of a Time Sensitive Networking, TSN, system, 100 integrated to a wireless communication network 80. As depicted in FIG. 1, the TSN system 100 may be integrated with the wireless communication network 80 to provide converged communication on a same network infrastructure for a wide range of services, for example, time sensitive applications that require deterministic, reliable and low latency communications.

The TSN system (also be referred to as TSN network) 100 may be based on the Institute of Electrical and Electronics Engineers, IEEE 802.3 Ethernet standard. The TSN system may provide deterministic services through IEEE 802.3 networks, for example, time synchronization, guaranteed low latency transmissions and high reliability.

The wireless communication network (also be referred to wireless communication system, cellular communication network/system, or the like) may be a wireless network, for example, a Fifth Generation, 5GS, network, a Long Term Evolution, LTE, network, an Evolved Universal Terrestrial Radio Access Network, E-UTRAN, a Wideband Code Division Multiple Access, WCDMA, network, a Global System for Mobile communications, GSM, network, a Worldwide Interoperability for Microwave Access, WiMAX, or any other future generation network.

The wireless communication network 80 comprises a Radio Access Network, RAN, 40 and a core network, CN, 60. The wireless communication network 100 may use a number of different Radio Access Technologies, RATs, such as LTE, LTE-Advanced, 5G, WCDMA, GSM/Enhanced Data rate for GSM Evolution, EDGE, WiMAX, Ultra Mobile Broadband, WMB, or the like.

The RAN 40 comprises one or more network nodes 40a, each providing radio coverage over one or more geographical areas, such as cells 25 supporting the one or more RATs. In some examples, the network node 40a may be a radio access node such as a radio network controller, an access point such as a Wireless Local Area Network, WLAN, access point or an Access Point Station, AP STA, an access controller, a base station, a base transceiver station, an Access Point base station, a base station router, a transmission arrangement of a radio base station, a standalone access point, or any other unit of the RAN capable of serving one or more User Equipments, UEs 30a, 30b, in the cell/service area. Examples of the base station may include, a gNodeB, gNB, an evolved Node B, eNB, and so on.

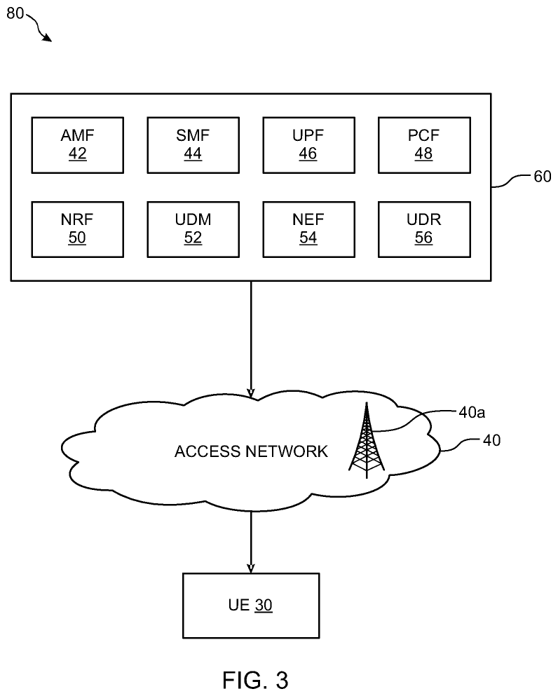

The CN 60 comprises a core network node. The core network node may be configured to communicate with the network node 40a via an interface, for example, an S1 interface. Examples of the core network node may include, a Mobile Switching Centre, MSC, a Mobility Management Entity, MME, an Operation and Management, O&M, node, an Operation, Administration and Maintenance, OAM, node, an Operations Support Systems, OSS, node, a Self-Organizing Network, SON, node, a Packet Data Network Gateway, P-GW, a Service Capability Exposure Function, SCEF, a Home Subscriber Server, HSS, or the like. The core network node may further be a distributed node comprised in a cloud 102. The core network node may further include a node implementing network functions of the CN 60 such as but are not limited to, an Access and Mobility Function, AMF, a User Plane Function, UPF, a Session Management Function, SMF, an Authentication Server Function, AUSF, a Network Slice Selection Function, NSSF, a Network Exposure Function, NEF, a Network Repository Function, NRF, a Policy Control Function, PCF, a Unified Data Management, UDM, and so on. The network functions of the CN 60 are described in detail in conjunction with FIG. 3.

In the wireless communication network 80, the one or more UEs 30a and 30b (collectively referred to as UE 30) may communicate with the CN 60 via the network nodes 40a of the RAN 40. Examples of the UE 30 may include, a wireless device, a mobile station, a non-access point, non-AP, station, STA, a wireless terminal, or the like. It should be understood by those skilled in the art that “wireless device” is a non-limiting term, which means any terminal, a wireless communication terminal, a User Equipment, a Mobile Type Communication, MTC, device, a Device to Device, D2D, terminal, or a node for example, a smart phone, a laptop, a mobile phone, a sensor, a relay, a mobile tablet, or even a base station communicating within the cell.

The UE 30 may be located in the cell 25 of the network node 40a, which is referred to as a serving cell and the cell of other network nodes may be referred to as neighbouring cells for the UE 30. Although the network node 40a, in FIG. 1, is only providing a serving cell 25, the network node 40a may further provide one or more neighbouring cells to the serving cell 25.

The UE 30 (also be referred to as first end station) may be connected to one or more end stations such as one or more second end stations. The second end station may include, but are not limited to, robots, a factory floor, or the like.

The wireless communication network 80 may according to some embodiments herein communicate with one or more nodes in the TSN system 100. The TSN system 100 may be connected to one or more end stations, such as, the second end stations.

According to some embodiments herein, with the integration of the TSN system 100, the wireless communication network 80 operates as a virtual TSN bridge (also be referred to as virtual TSN node, virtual wireless bridge, or the like).

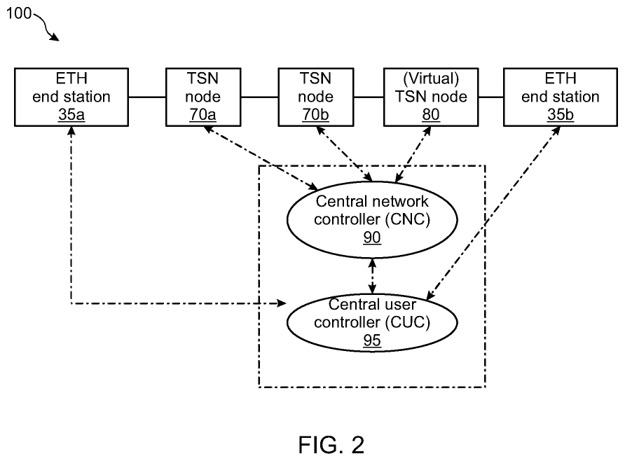

FIG. 2 discloses an example of the TSN system 100 integrated to the wireless communication network 80, wherein the wireless communication network 80 operates as the virtual TSN bridge. The TSN system 100 comprises one or more TSN bridges. For simplicity, the TSN system 100 comprising TSN bridges 70a and 70b is depicted in FIG. 2. The TSN bridges 70a and 70b may be wired TSN bridges (also be referred to as wired nodes, wired TSN nodes, or the like). With the integration of the TSN system 100 to the wireless communication network 80, the TSN system 100 may comprise the virtual TSN bridge 80. The virtual TSN bridge 80 referred herein may be the wireless communication network 80 or the virtual TSN bridge 80 may be a node implemented by the wireless communication network 80.

The TSN bridges 70a and 70b, and the virtual TSN bridge 80 may be connected to one or more end stations, for example, second end stations, which suppose to exchange time sensitive communication. The time sensitive communication may comprise TSN streams or TSN packets, or TSN flows to be exchanged between the end stations. As depicted in FIG. 2, the TSN bridge 70a may be connected to an end station 35a and the virtual TSN bridge 80 may be connected to an end station 35b. Examples of the end stations 35a and 35b may include, but are not limited to, robots, a factory floor, or the like. The end stations 35a and 35b may be connected to the UEs associated with the virtual TSN bridge 80 through the TSN bridges 70a/70b (not shown).

In some examples, the TSN bridges 70a and 70b, the virtual TSN bridge 80, and the end stations 35a and 35b may be configured in a static configuration setup or a centralized network configuration setup. In the static configuration setup, the TSN bridges 70a and 70b, the virtual TSN bridge 80, and the end stations 35a and 35b may be configured during network setup. In the centralized network configuration setup, a Centralized Network Controller, CNC, 90 (also be referred to as centralized network configuration, TSN controller, or the like) may configure the TSN bridges 70a and 70b, and the virtual TSN bridge 80 for TSN streams (data packets exchanged between the end stations through the TSN bridges 70a and 70b and the virtual TSN bridge 80). The CNC 90 may be adapted for configuring network resource reservations for the TSN bridges 70a and 70b, and the virtual TSN bridge 80. The CNC 90 may also be adapted for coordinating any changes to the configured network resource reservations with any new reservations. The network resource reservations may be made or requested by the end stations 35a and 35b. In the fully centralized network configuration setup where both network and user configuration are centralized, the CNC may receive requirements of data flows from a Centralized User Controller, CUC, 95 (also be referred to as centralized user configuration) and then compute a route, and a time schedule required for end-to-end, E2E, transmission for each TSN stream. The CNC may also configure the TSN bridges 70a and 70b and the virtual TSN bridge 80 in accordance with the computed route and time schedule.

In some embodiments, the wireless communication network acting as the virtual TSN bridge 80 may obtain, from a controller of the TSN system (not shown) or the CNC 90, one or more TSN Quality of Service, QoS, parameters and information related to a traffic pattern for the virtual TSN bridge 80. The TSN QoS parameters may be mapped to QoS policy(ies) and/or rules in the wireless communication network and applied in the wireless communication network in order to satisfy TSN QoS requirements for the virtual TSN bridge. In addition, at least some of the information related to the traffic pattern for the virtual TSN bridge may be provided to an edge node to achieve the desired traffic pattern. In some examples, the edge node may be the UPF of the CN for uplink direction or the UE for downlink direction.

In some other embodiments, the wireless communication system operating as the virtual TSN bridge 80 may obtain, from the controller of the TSN system or the CNC 90, information related to the traffic pattern for the preceding TSN bridge 70b (the TSN bridge that precedes the virtual TSN bridge 80 in a direction of TSN traffic flow). At least some of the information related to the traffic pattern for the preceding TSN bridge 70b may be provided to the one or more network nodes of the wireless communication system for radio optimization. Components of the wireless communication network operating as the virtual TSN bridge 80 is described in detail in conjunction with FIG. 3.

FIG. 3 discloses the wireless communication network 80 operating as the virtual TSN bridge, while integrated to the TSN system. As depicted in FIG. 3, the wireless communication network 80 comprises the RAN 40, the CN 60, and the UE 30. The RAN 40 includes the network node 40a.

The network node 40a may be directly connected to the UE 30. The network node 40a may include a group of a plurality of base stations including a base station, and the plurality of base stations may perform communication via an interface. The base station may have a structure having a central unit, CU, and a distributed unit, DU, separated from each other. In this case, one CU may control a plurality of DUs. The base station may be referred to as an access point, AP, a next-generation node i.e., a gNB, a 5th generation node, a wireless point, or a transmission/reception point, TRP, or the like. The UE 30 accesses the RAN 40 and communicates with the network node 40a through a wireless channel. The UE 30 may be a user equipment, UE, a mobile station, a subscriber station, a remote terminal, a wireless terminal or the like.

The CN 60, which is the network that manages or controls the RAN 40 and processes data and control signals for the UE 30, transmitted and received via the RAN 40. The CN 60 may perform various functions including control of a user plane and a control plane, processing of mobility, management of subscriber information, charging, and interworking with other types of systems such as, LTE, system.

To perform the various functions described above, the CN 60 may include a plurality of functionally separated entities (i.e., core network nodes) having different network functions. For example, the network functions may include an AMF 42, a SMF 44, a UPF 46, a PCF 48, a network repository function, NRF 50, a UDM 52, a NEF 54, and a unified data repository UDR 55. Although, not shown in FIG. 3, the CN 60 may interwork with a TSN Application Function, AF, the CNC and the TSN system. In some examples, the CN 60 may be referred as a 5th generation, 5G, core, 5GC, which is a core network of a 5G system.

The UE 30 connected to the RAN 40 may accesses the AMF 42, which performs a mobility management function of the CN 60. The AMF 42 is a function or a device that is responsible for both access to the RAN 40 and the mobility management of the UE 30. The SMF 44 is a network function that manages a session. The AMF 42 may be connected to the SMF 44, and the AMF 42 may route session-related messages of the UE 30 to the SMF 44. The SMF 44 may be connected to the UPF 46 to allocate a user plane resource to be provided to the UE 30 and establish a tunnel for transmitting data between the network node 40a and the UPF 46. The SMF 44, as a main entity managing a Protocol Data Unit, PDU session, may be responsible for QoS setting/update for QoS flows in the PDU session. The PCF 48 may control information associated with a policy and charging of a session used by the UE 30. The NRF 50 may be connected to all the network functions. Each network function is registered with the NRF 50 when starting to run in the operator network, so as to inform the NRF 50 that the network function is running in the wireless communication network 80. The UDM 52, as a network function may perform a role similar to a home subscriber server, HSS, of a 4G network, and store subscription information of the UE 30 or context information used by the UE 30 in the network.

The NEF 54 may serve to connect a third party server to the network function in the wireless communication network 80. In addition, the NEF 54 may serve to provide data to the UDR 56 and to update or obtain data. The UDR 56 may serve to store subscription information of the UE 30, store policy information, store data exposed to the outside, or store information necessary for a third-party application. Further, the UDR 56 may also serve to provide stored data to other network functions.

The UDM 52, PCF 48, SMF 44, AMF 42, NRF 50, NEF 54, and UDR 56 may be connected to a service-based interface. Services or application programing interfaces, APIs, provided by these network functions are used by other network functions and thus may exchange control messages with each other. For example, when the AMF 42 delivers a session-related message to the SMF 44, a service or API called Nsmf_PDUSession_CreateSMContext may be used.

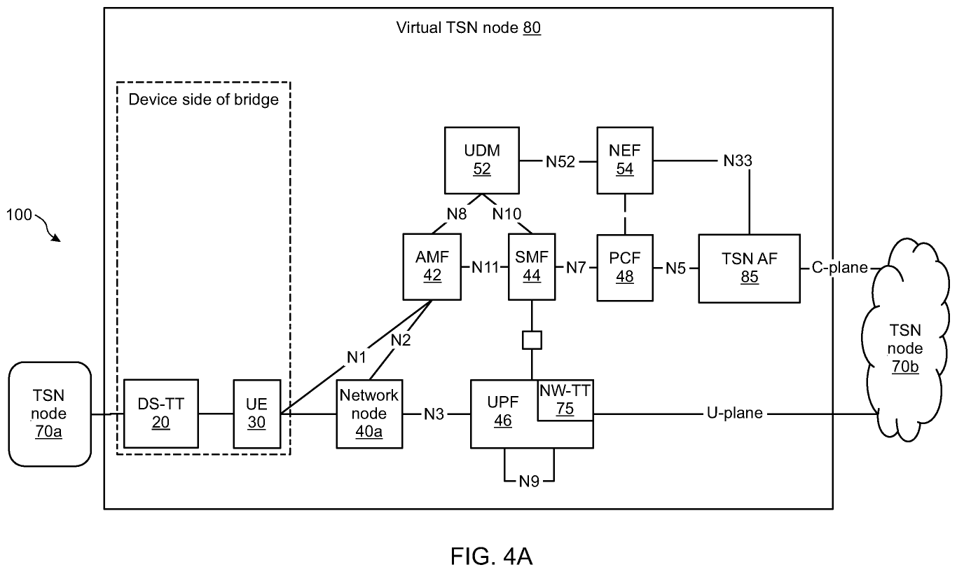

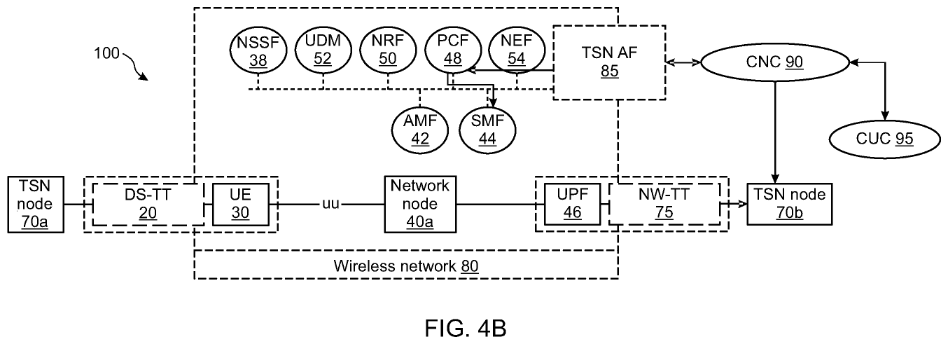

FIGS. 4A and 4B disclose an example architecture of the TSN system 100 integrated with the wireless communication network 80 in which embodiments of the present disclosure may be implemented. For a seamless integration between the wireless communication network 80 and the TSN system 100, the wireless communication network 80 and the TSN system 100 may interoperate in a transparent manner to minimize impact on other TSN entities.

With the integration of the TSN system 100 to the wireless communication network 80, the TSN system 100 comprises the one or more TSN bridges/wired TSN bridges 70a and 70b, and the virtual TSN bridge 80. The TSN bridges 70a and 70b and the virtual TSN bridge 80 are described in detail in conjunction with FIG. 2.

The virtual TSN bridge/wireless communication network 80 comprises the RAN and the CN. The RAN comprises the network node 40a. The CN comprises network functions such as, the AMF 42, the SMF 44, the PCF 48, the NEF 54, the UDM 52, the UPF 46, or the like. All these network functions of the CN are described in detail in conjunction with FIG. 3.

In some examples, the virtual TSN bridge/wireless communication network 80 may define several gateways, which enable the virtual TSN bridge 80 to communicate with the TSN system 100 and the CNC 90. The gateways may include the TSN AF 85, a device side TSN translator, DS-TT, 20, on the UE 30, and a network side TSN translator, NW-TT, 75 on the UPF 46 of the CN. TSN ingress ports and egress ports may be provided via the DS-TT 20 on the UE 30 and via the NW-TT 75 on the CN.

The TSN AF 85 may be configured to connect the CNC 90, the CUC 95 entities and a control plane, C-plane. In some examples, the TSN AF 85 may be associated with the CN. In some examples, the TSN AF 85 may be a third party entity outside an operator network or an entity inside the operator network. For example, the TSN AF 85 may be an entity within the CN, which is inside the operator network, since the CN corresponds to an essential function for supporting TSN. The TSN AF 85 may derive information about a TSN stream from information provided by the CNC 90 in the form of bridge management information, and possibly using other configuration data. The TSN AF 85 may determine QoS parameters including: a priority, a Maximum Burst Size, a delay and a Maximum Bitrate, and may provide these parameters to the PCF 48.

In some examples, the DS-TT 20 and the NW-TT 75 may support hold and forward functionality of purpose of de-jittering, and per-stream filtering and policing as defined in clause 8.6.5.1 of IEEE std 802.1Q. The DS-TT 20 may optionally support link layer connectivity discovery and reporting as defined in IEEE std 802.1AN for discovery of the end stations attached to the DS-TT 20. The NW-TT 75 may support link layer connectivity discover and reporting as defined in IEEE std 802.1AB for discovery of the end stations attached to the NW-TT 75. If the DS-TT 20 does not support the link layer connectivity discovery and reporting, the NW-TT 75 may perform the link layer connectivity discovery and reporting as defined in IEEE std 802.1AB for discovery of the end stations attached to the DS-TT 20 on behalf of the DS-TT 20.

Further, as depicted in FIG. 4B, the CNC 90 may be adapted to configure and operate the TSN bridges 70a and 70b of the TSN system 100 and the virtual TSN bridge 80. Configuring, by the CNC, the TSN bridges 70a and 70b of the TSN system 100 and the virtual TSN bridge 80 are described in detail in FIG. 2.

The CNC 90 operates the virtual TSN bridge 80 by considering the virtual TSN bridge as the wired TSN bridge 70a/70b. However, there are some substantial differences between the virtual TSN bridge 80 and the TSN bridge 70a/70b. One of key differences between the TSN bridges and the virtual TSN bridge is that characteristics of the virtual TSN bridge may vary dynamically, especially compared to relatively static characteristics of the TSN bridges. When the characteristics of the virtual TSN bridge change, a new interaction between the virtual TSN bridge and the CNC may be triggered. Currently defined interaction model for facilitating the virtual TSN bridge and the CNC may function well, only if the virtual TSN bridge is the wired TSN bridge.

In the TSN system 100 integrated to the wireless communication network 80, all the UEs 30 are connected to the same UPF 46. Thus, all bridge reports comprising information about the UPF 46 and the associated one or more UEs 30 can be transmitted towards the CNC 90, which contain information per port pair. However, such a bridge report per bridge/port pair may be sufficient for the TSN bridges 70a, and 70b and may not be efficient for the virtual TSN bridge, since any change in the UE 30 may lead to an updated bridge report. Thus, resulting in high signaling load. In addition, a frequency of reporting the bridge report per port pair may also increase.

Therefore, according to some embodiments of the present disclosure, the network node 40a in the wireless communication network/virtual TSN bridge 80, implements a method for enabling of reporting multiple bridges in the TSN system 100.

The network node 40a identifies the UEs 30 associated to the virtual TSN bridge 80 of the TSN system 100. The network node 40a divides the UEs 30 into groups according to latency characteristics of the UEs 30. Upon grouping of the UEs 30, the network node 40a associates at least some of the UEs 30 to at least one additional virtual TSN bridge of the TSN system 100 based on the grouping of the UEs 30. Grouping of the UEs 30 and accordingly associating at least some of the UEs 30 to the at least one additional virtual TSN bridge results in enabling of reporting multiple bridges.

In some embodiments, the network node 40a may transmit information identifying the association of the respective UE 30 to the corresponding virtual TSN bridge 80. The information may be intended for the CNC 90 of the TSN system.

In some embodiments, the network node 40a may group the ports such as, the DS-TTs 20 and the NW-TTs 75 as PDU session ports and N6-side ports. The network node 40a may transmit information about grouping of the ports per group basis. The information may be intended for the CNC 90 of the TSN system 100.

Various examples for enabling of reporting multiple bridges are explained in conjunction with figures in the later parts of the description.

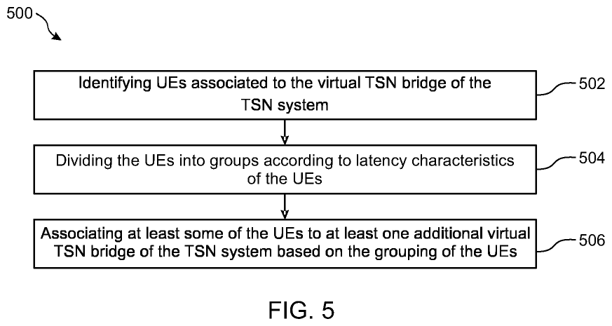

FIG. 5 is a flowchart illustrating example method steps of a method 500 performed by the network node in the wireless communication network. The wireless communication network operates as the virtual TSN bridge of the TSN system. The virtual TSN bridge is connected to the plurality of TSN bridges.

At step 502, the method 500 comprises identifying the UEs associated to the virtual TSN bridge of the TSN system.

At step 504, the method 500 comprises dividing the identified UEs into groups according to latency characteristics of the UEs. In some embodiments, the step 504 of dividing the UEs into groups according to the latency characteristics of the UEs may comprise determining latency characteristics associated with each UE. Based on the determined latency characteristics, the method may comprise identifying the UEs with varying latency characteristics and the UEs with static latency characteristics. Upon identification, the method may comprise grouping the UEs with varying latency characteristics in a first group (for example, a dynamic group) and grouping the UEs with static latency characteristics in at least a second group (for example, a static group).

Upon grouping of UEs, at step 506, the method 500 comprises associating at least some of the UEs to at least one additional virtual TSN bridge of the TSN system based on the grouping of the UEs. In some embodiments, the step 506 of associating the at least some of the UEs to the at least one additional virtual TSN bridge based on the number of UEs in each group.

Consider an example scenario, wherein the virtual TSN bridge (for example, a virtual TSN bridge 1) is associated with 99 UEs, with at least one port (i.e., the NW-TT) at the UPF and a number of UEs for device-side ports (i.e., the DS-TTs). In such a scenario, the network node identifies the latency characteristics of each of the 99 UEs. Based on the identified latency characteristics, the network node determines that 50 of the 99 UEs are associated with static/constant latency characteristics and remaining 49 of the 99 UEs are associated with varying latency characteristics. The network node divides the 50 UEs with static latency characteristics into the first group/static group and the 49 UEs with varying latency characteristics into the second group/dynamic group. The network node associates the 50 UEs of the static group to the virtual TSN bridge 1. The network node associates the 49 UEs of the dynamic group to additional 5 virtual TSN bridges 2, 3, 4, 5, and 6, wherein 10 UEs each are associated to the additional virtual TSN bridges 2-5 and the remaining 9 UEs are associated to the additional virtual TSN bridge 6. In some examples, a size of the virtual TSN bridge comprising the UEs with varying latency characteristics (for example, the virtual TSN bridges 2-6) may be held small (i.e., to comprise fewer UEs), so that a frequency of updating of reporting multiple bridges may be controlled.

In some embodiments, the method 500 may further comprise transmitting information identifying the association of the respective UE to the corresponding virtual TSN bridge. The information may be intended for the CNC of the TSN system. In some examples, the transmitted information to the CNC may comprise the number of UEs in each group associated each virtual TSN bridge, port-pairs of each virtual TSN bridge with static latency characteristics and port-pairs of each virtual TSN bridge with dynamic latency characteristics. The number of UEs in each group represents one port of the associated virtual TSN bridge. In some examples, the transmitted information comprising port pairs, each port pair comprising a port of a UE and a port of its associated virtual TSN bridge. The port information comprises information identifying whether the port pair has static latency characteristics or dynamic latency characteristics.

The network node may transmit the information identifying the association of the respective UE to the corresponding virtual TSN bridge to the CNC through the one or more network functions of the CN connected to the network node.

In some examples, upon reception of the information identifying the association of the respective UE to the corresponding virtual TSN bridge, the CNC performs reconfiguration of the TSN system. In some examples, reconfiguration of the TSN system may comprise updating forwarding paths for TSN streams and TSN features (for example, IEEE 802.1AS time synchronization) and accordingly reconfiguring the TSN bridges and the virtual TSN bridge.

Thus, grouping of the UEs, associating at least some of the UEs the at least one additional virtual TSN bridge based on the number of UEs in each group and transmitting information identifying the association of the respective UE to the corresponding virtual TSN bridge, enables the UPF to report as multiple bridges.

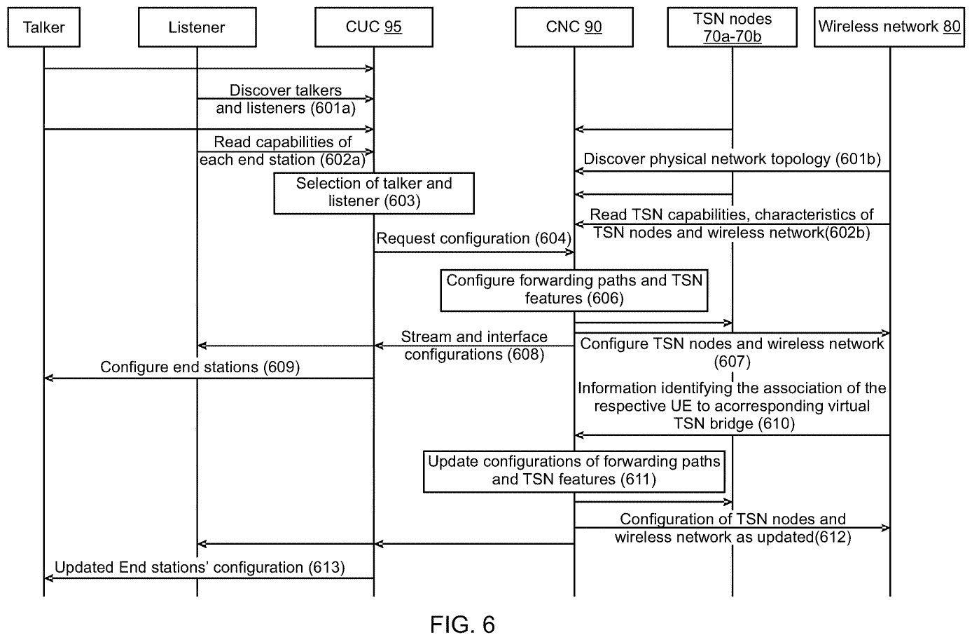

FIG. 6 is a signaling diagram illustrating example signaling for configuring and reconfiguring the TSN system. As depicted in FIG. 6, the TSN system comprising the TSN bridges 70a and 70b may be integrated to the wireless communication network 80 operating as the virtual TSN bridge. The CNC 90 operates the TSN bridges 70a and 70b and the wireless communication network/virtual TSN bridge 80.

The CUC 95 discovers (601a) a talker and a listener supposed to exchange time sensitive communication/TSN streams. In some examples, if the integration of the TSN system to the wireless communication network 80 is deployed in an automated industry, the CUC 95 receives an input from an industrial application/engineering, for example, a Programmable Logic Controller, PLC, which indicates the talkers and listeners supposed to exchange the time sensitive communication. Herein, the talker may be a sender or source end station and the listener may be a receiver or destination end station.

Upon discovering the talker and the listener, the CUC 95 reads (602a) capabilities of the talker and listener (the end stations) in the TSN system that includes information about period/interval of user traffic and payload sizes.

Based on the capabilities of the talker and the listener, the CUC 95 selects (603) the talker and listener for each TSN steam and creates other stream related information such as, but are not limited to, a stampID as an identifier for each TSN stream, a stream rank, and user to network requirements.

Meanwhile, the CNC 90 discovers (601b) a physical network topology using, for example, a Link Layer Discovery Protocol, LLDP, and any network management protocol, such as, a Remote Management Protocol, RMP. The CNC 90 reads (602b) TSN capabilities of the TSN bridges, for example, TSN bridges 70a and 70b, (for example, IEEE 802.1Q, 802.1AS, 802.1CB) in the TSN system by means of the network management protocol.

Upon selecting the talker and listener for each TSN stream (at step 603), the CUC 95 initiates (604) join requests to configure the TSN stream in order to configure network resources at the TSN bridges 70a and 70b for the TSN stream from the talker to the listener. Also, the CUC 95 may create talker and listener groups (a group of elements specifying the TSN stream) as specified in IEEE 802.1Q.

Based on the initiated join request, the CNC 90 configures (606) forwarding paths for the TSN streams and TSN features (for example, IEEE 802.1AS time synchronization). Based on the configured forwarding paths and the TSN features, the CNC 90 configures (607) the TSN bridges 70a and 70b and the wireless communication network 80. The CNC 90 transmits (608) stream and interface configurations to the CUC 95. The CNC 90 configures (609) the end stations/talker and listener.

On configuring the TSN bridges 70a and 70b, the wireless communication network 80, and the end stations, the wireless communication network 80 (i.e., the network node in the wireless communication network 80) transmits (610) information identifying the association of the respective UE to the corresponding virtual TSN bridge to the CNC 90. In some examples, the information may comprise the number of UEs in each group associated to each virtual TSN bridge, wherein the number of UEs in each group represents one port of the associated virtual TSN bridge. Thus reporting multiple bridges.

In accordance with the received information identifying the association of the respective UE to the corresponding virtual TSN bridge, the CNC 90 updates/reconfigures (611) the forwarding paths and the TSN features. Based on the reconfigured forwarding paths and the TSN features, the CNC 90 reconfigures (612) the TSN bridges 70a and 70b and the wireless communication network 80. The CNC 90 also reconfigures (613) the end stations/talkers and listeners.

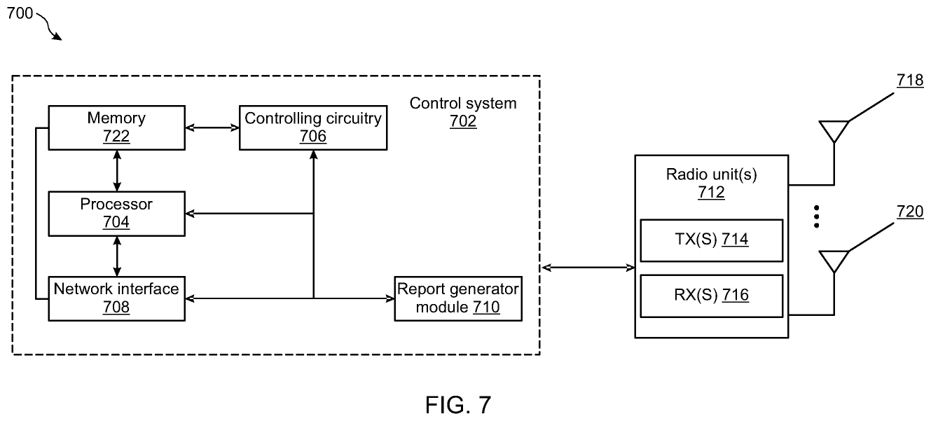

FIG. 7 is a schematic block diagram illustrating an example apparatus 700 in the network node of the wireless communication network. The apparatus 700 may e.g. be comprised in the network node. The apparatus 700 is capable of enabling of reporting multiple bridges and may be configured to cause performance of the method 500 for enabling of reporting multiple bridges in the TSN system.

As depicted in FIG. 7, the apparatus 700 comprises a control system 702 that includes a memory 722, one or more processors 704, a controlling circuitry 706, a network interface 708, and a report generator module 710. The memory 722, the one or more processors 704, the controlling circuitry 706, the network interface 708, and the report generator module 710 may be operatively connected to each other. Examples of the one or more processors 704 (also referred to as processing circuitry) may include, Central Processing Units, CPUs, Application Specific Integrated Circuits, ASICs, Field Programmable Gate Arrays, FPGAs, and so on.

In addition, the apparatus 700 comprises radio units 712 that each includes one or more transmitters 714 and one or more receivers 716 coupled to one or more antennas 718 and 720. The radio units 712 may be referred to or be part of radio interface circuitry. In some embodiments, the radio unit(s) 712 is external to the control system 702 and connected to the control system 702 via, e.g., a wired connection (e.g., an optical cable). However, in some other embodiments, the radio unit(s) 712 and potentially the antenna(s) 714 and 716 are integrated together with the control system 702.

The controlling circuitry 706, may in some embodiments be adapted to control the above mentioned components of the apparatus 700. The controlling circuitry 706 may be adapted to control the steps as executed by the network node. For example, the controlling circuitry 806 may be adapted to enabling of reporting multiple bridges in the TSN system (as described above in conjunction with the method 500 and FIG. 5).

The report generator module 710 may be adapted to divide the UEs associated with the virtual TSN bridge of the TSN system into groups according to latency characteristics of the UEs and associating at least some of the UEs to the at least one additional virtual TSN bridge of the TSN system based on the grouping of UEs.

The network interface 708 may be adapted to transmit information identifying the association of the respective UE to the corresponding virtual TSN bridge. Said information may be intended for the CNC of the TSN system.

The one or more processors 704 may be adapted to identify the UEs associated with the virtual TSN bridge.

The memory 722 may store at least one of information about at least one of: the UEs associated with the virtual TSN bridge, the latency characteristics of the UEs, grouping of the UEs, the association of the number of UEs in each group to the corresponding virtual TSN bridge, and so on.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors, DSPs, special-purpose digital logic, and the like. The processing circuitry may be configured to execute program code stored in memory, which may include one or several types of memory such as read-only memory (ROM), random-access memory, RAM, cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the disclosure.

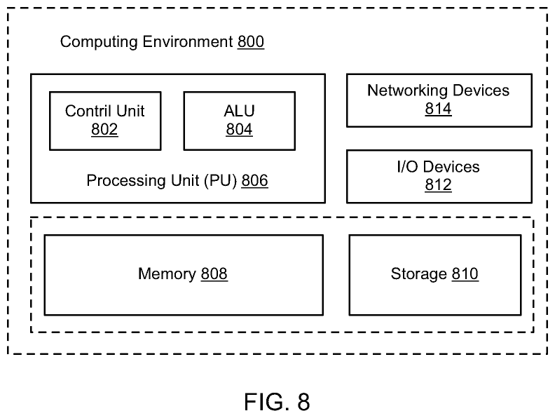

FIG. 8 illustrates an example computing environment 800 implementing a method and the apparatus, as described in FIGS. 5 and 7. As depicted in FIG. 8, the computing environment 800 comprises at least one data processing module 806 that is equipped with a control module 802 and an Arithmetic Logic Unit (ALU) 804, a plurality of networking devices 814 and a plurality Input output, I/O devices 812, a memory 808, a storage 810. The data processing module 806 may be responsible for implementing the method described in FIG. 5. For example, the data processing module 806 may in some embodiments be equivalent to the CPU/processor/controller of the apparatus described above in conjunction with the FIG. 8. The data processing module 806 is capable of executing software instructions stored in memory 808. The data processing module 806 receives commands from the control module 802 in order to perform its processing. Further, any logical and arithmetic operations involved in the execution of the instructions are computed with the help of the ALU 804.

The computer program is loadable into the data processing module 806, which may, for example, be comprised in an electronic apparatus (such as a network node). When loaded into the data processing module 806, the computer program may be stored in the memory 808 associated with or comprised in the data processing module 806. According to some embodiments, the computer program may, when loaded into and run by the data processing module 806, cause execution of method steps according to, for example, any of the method illustrated in FIG. 5 or otherwise described herein.

The overall computing environment 800 may be composed of multiple homogeneous and/or heterogeneous cores, multiple CPUs of different kinds, special media and other accelerators. Further, the plurality of data processing modules 806 may be located on a single chip or over multiple chips.

The algorithm comprising of instructions and codes required for the implementation are stored in either the memory 808 or the storage 810 or both. At the time of execution, the instructions may be fetched from the corresponding memory 808 and/or storage 810, and executed by the data processing module 806.

In case of any hardware implementations various networking devices 814 or external I/O devices 812 may be connected to the computing environment to support the implementation through the networking devices 814 and the I/O devices 812.

The embodiments disclosed herein can be implemented through at least one software program running on at least one hardware device and performing network management functions to control the elements. The elements shown in FIG. 8 include blocks which can be at least one of a hardware device, or a combination of hardware device and software module.

1. A method performed by a network node of a wireless communication network, the wireless communication network operating as a virtual Time-Sensitive Networking, TSN, bridge of a TSN system the method comprising:
identifying User Equipments, UEs, associated to the virtual TSN bridge of the TSN system;
dividing the UEs into groups according to latency characteristics of the UEs; and
associating plurality of the UEs to at least one additional virtual TSN bridge of the TSN system based on the grouping of the UEs.

2. The method according to claim 1, wherein dividing the UEs into groups according to latency characteristics of the UEs comprises:
determining latency characteristics associated with each UE;
identifying the UEs with varying latency characteristics and the UEs with static latency characteristics based on the determined latency characteristics; and
grouping the UEs with varying latency characteristics in a first group and grouping the UEs with static latency characteristics in at least a second group.

3. The method according to claim 1, wherein of associating the plurality of the UEs to the at least one additional virtual TSN bridge of the TSN system based on the grouping of the UEs comprises:
determining the number of the UEs in each group; and
associating each group of UEs to the at least one additional virtual TSN bridge based on the number of UEs in each group.

4. The method according to claim 1, further comprising:
transmitting information identifying the association of the respective UE to the corresponding virtual TSN bridge, the information being intended for a Centralized Network Controller, CNC, of the TSN system.

5. The method according to claim 4, wherein the transmitted information to the CNC comprises the information identifying all the UEs in each group associated to each virtual TSN bridge, wherein the UEs in each group represents one port of the associated virtual TSN bridge.

6. The method according to claim 4, wherein the transmitted information further comprises:
port information comprising port pairs, each port pair comprising a port of a UE and a port of its associated virtual TSN bridge.

7. The method according to claim 6, wherein the port information comprises:
information identifying whether the port pair has static latency characteristics or dynamic latency characteristics.

8. An apparatus of a network node of a wireless communication network the wireless communication network operating as a virtual Time-Sensitive Networking, TSN, bridge of a TSN system, the apparatus is configured to cause:
identification of User Equipments, UEs, associated to the virtual TSN bridge of the TSN system;
dividing of the UEs into groups according to latency characteristics of the UEs; and
association of a plurality of the UEs to at least one additional virtual TSN bridge of the TSN system based on the grouping of the UEs.

9. The apparatus according to claim 8, wherein the apparatus is configured to cause dividing of the UEs into groups according to latency characteristics of the UEs by causing:
determination of latency characteristics associated with each UE;
identification of the UEs with varying latency characteristics and the UEs with static latency characteristics based on the determined latency characteristics; and
grouping of the UEs with varying latency characteristics in a first group and grouping the UEs with static latency characteristics in at least a second group.

10. The apparatus according to claim 8, wherein the apparatus is configured to cause association of the plurality of the UEs to the at least one additional virtual TSN bridge of the TSN system based on the grouping of the UEs by causing:
determination of the number of the UEs in each group; and
association of each group of UEs to the at least one additional virtual TSN bridge based on the number of UEs in each group.

11. The apparatus according to claim 8, wherein the apparatus is further configured to cause:
transmission of information identifying the association of the respective UE to the corresponding virtual TSN bridge, the information being intended for a Centralized Network Controller, CNC, of the TSN system.

12. The apparatus according to claim 11, wherein the transmitted information to the CNC comprises the number of UEs in each group associated to each virtual TSN bridge, wherein the number of UEs in each group represent one port of the associated virtual TSN bridge.

13. The apparatus according to claim 11, wherein the transmitted information further comprises:
port information comprising port pairs, each port pair comprising a port of a UE and a port of its associated virtual TSN bridge.

14. The apparatus according to claim 13, wherein the port information comprises:
information identifying whether the port pair has static latency characteristics or dynamic latency characteristics.

15. A network node for a wireless communication network, the network node comprising an apparatus, the wireless communication network operable as a virtual Time-Sensitive Networking, TSN, bridge of a TSN system, the apparatus is configured to cause:
identification of User Equipments, UEs, associated to the virtual TSN bridge of the TSN system;
dividing of the UEs into groups according to latency characteristics of the UEs; and
association of a plurality of the UEs to at least one additional virtual TSN bridge of the TSN system based on the grouping of the UEs.

16. (canceled)

17. The method according to claim 2, wherein associating the plurality of the UEs to the at least one additional virtual TSN bridge of the TSN system based on the grouping of the UEs comprises:
determining the number of the UEs in each group; and
associating each group of UEs to the at least one additional virtual TSN bridge based on the number of UEs in each group.

18. The method according to claim 2, further comprising:
transmitting information identifying the association of the respective UE to the corresponding virtual TSN bridge, the information being intended for a Centralized Network Controller, CNC, of the TSN system.

19. The method according to claim 18, wherein the transmitted information to the CNC comprises the information identifying all the UEs in each group associated to each virtual TSN bridge, wherein the UEs in each group represents one port of the associated virtual TSN bridge.

20. The method according to claim 18, wherein the transmitted information further comprises:
port information comprising port pairs, each port pair comprising a port of a UE and a port of its associated virtual TSN bridge.

21. The method according to claim 20, wherein the port information comprises:
information identifying whether the port pair has static latency characteristics or dynamic latency characteristics.
